(19) United States
(12) Patent Application Publication
(10) Pub. No.: US 2015/0358728 A1
(43) Pub. Date: Dec. 10, 2015

(54) ACTIVE NOISE CANCELLATION METHOD FOR AIRCRAFT

(71) Applicant: Lloyd Trammell, Thousand Oaks, CA (US)

(72) Inventor: Lloyd Trammell, Thousand Oaks, CA (US)

(73) Assignee: Max Sound Corporation, La Jolla, CA (US)

(21) Appl. No.: 14/189,982

(22) Filed: Feb. 25, 2014

Related U.S. Application Data
(60) Provisional application No. 61/769,096, filed on Feb. 25, 2013.

(51) Int. Cl. H04R 3/00

(52) U.S. Cl. CPC H04R 3/002

(57) ABSTRACT

A Noise Cancellation Process for Aircraft is disclosed. According to one embodiment, an input audio source corresponding to sound received from multiple microphones situated equidistantly in both directions in a two dimensional plane, is converted to a digital signal via an analog to digital (A/D) convertor. The A/D converted audio is analyzed for content to identify ambient noise. The frequency, amplitude and phase of the identified ambient noise is subsequently determined. A Noise correction sound wave is generated with negative phase of that corresponding to the identified ambient noise. The noise correction sound wave is added to the identified noise to create a noise corrected sound.

### CROSS-REFERENCE TO RELATED PATENT APPLICATIONS

Embodiments of the present invention relate to U.S. Provisional Application Ser. No. 61/769,096, filed Feb. 25, 2013, entitled “ACTIVE NOISE CANCELLATION FOR AIRCRAFT”, the contents of which are incorporated by reference herein and which is a basis for a claim of priority.

### BACKGROUND OF THE INVENTION

The present invention relates to a method and device for enhancing an audio source by reducing and eliminating background and other ambient noise in Aircrafts.

Active noise control (ANC), also known as noise cancellation, or active noise reduction (ANR), is a method for reducing unwanted sound by the addition of a second sound specifically designed to cancel the first¹. Sound is a pressure wave, which consists of a compression phase and a rarefaction phase. A noise-cancellation speaker emits a sound wave with the same amplitude but with inverted phase (also known as antiphase) to the original sound. The waves combine to form a new wave, in a process called interference, and effectively cancel each other out—an effect which is called phase cancellation². ¹http://en.wikipedia.org/wiki/Active_noise_control²See, n.1, above.

Modern active noise control is generally achieved through the use of analog circuits or digital signal processing. Adaptive algorithms are designed to analyze the waveform of the background aural or nonaural noise, then based on the specific algorithm generate a signal that will either phase shift or invert the polarity of the original signal. This inverted signal (in antiphase) is then amplified and a transducer creates a sound wave directly proportional to the amplitude of the original waveform, creating destructive interference. This effectively reduces the volume of the perceivable noise³. ³See, n.1, above.

FIG. 1 provides an example—A noise-cancellation speaker may be co-located with the sound source to be attenuated. In this case it must have the same audio power level as the source of the unwanted sound. Alternatively, the transducer emitting the cancellation signal may be located at the location where sound attenuation is wanted (e.g. the user's ear). This requires a much lower power level for cancellation but is effective only for a single user. Noise cancellation at other locations is more difficult as the three dimensional wavefronts of the unwanted sound and the cancellation signal could match and create alternating zones of constructive and destructive interference, reducing noise in some spots while doubling noise in others. In small enclosed spaces (e.g. the passenger compartment of a car) global noise reduction can be achieved via multiple speakers and feedback microphones⁴. ⁴See, n.1, above.

These systems are typically a “static” type of system, meaning that someone or something has taken a reading of a particular enclosed area at a single moment in time. A system operating in this way is marginally effective, but still effective in some small way, and never removes the majority of offending noises as they continually change. There are many things that add to these changes such as the number of people in the space, which usually changes several times a day; the temperature and humidity have an affect on the acoustic properties of a space; any “new” type of noise added into the space; outside noise that gets into the space; and environmental noises from outside the space⁵. Therefore there are many factors that are detrimental to the operation of a typical noise canceling system. Any single or multiple of these things can dramatically change the acoustic properties of a room as well⁶. ⁵See, n.1, above.⁶See, n.1, above.

A moving aircraft including the jet engine or propeller causes compression and rarefaction of the air, producing motion of air molecules. This movement propagates through the air as pressure waves. If these pressure waves are strong enough and within the audible frequency spectrum, a sensation of hearing is produced. Different aircraft types have different noise levels and frequencies. The noise originates from three main sources⁷: ⁷http://en.wikipedia.org/wiki/Aircraft_noise
Aerodynamic noise
Engine and other mechanical noise
Noise from aircraft systems

Aerodynamic noise arises from the airflow around the aircraft fuselage and control surfaces. This type of noise increases with aircraft speed and also at low altitudes due to the density of the air. Jet-powered aircraft create intense noise from aerodynamics. Low-flying, high-speed military aircraft produce especially loud aerodynamic noise⁸. The shape of the nose, windshield or canopy of an aircraft affects the sound produced. Much of the noise of a propeller aircraft is of aerodynamic origin due to the flow of air around the blades. The helicopter main and tail rotors also give rise to aerodynamic noise. This type of aerodynamic noise is mostly low frequency determined by the rotor speed⁹. ⁸See, n.7, above.⁹See, n.7, above.

Typically noise is generated when flow passes an object on the aircraft, for example the wings or landing gear. There are broadly two main types of airframe noise¹⁰. ¹⁰See, n.7, above.
Bluff Body Noise—the alternating vortex shedding from either side of a bluff body, creates low pressure regions (at the core of the shed vortices) which manifest themselves as pressure waves (or sound). The separated flow around the bluff body is quite unstable, and the flow “rolls up” into ring vortices—which later break down into turbulence.
Edge Noise—when turbulent flow passes the end of an object, or gaps in a structure (high lift device clearance gaps) the associated fluctuations in pressure are heard as the sound propagates from the edge of the object (radially downwards).

Much of the noise in propeller aircraft comes equally from the propellers and aerodynamics. Helicopter noise is aerodynamically induced noise from the main and tail rotors and mechanically induced noise from the main gearbox and various transmission chains. The mechanical sources produce narrow band high intensity peaks relating to the rotational speed and movement of the moving parts. In computer modeling terms noise from a moving aircraft can be treated as a line source¹¹. ¹¹See, n.7, above.

Aircraft Gas Turbine engines (Jet Engines) are responsible for much of the aircraft noise during takeoff and climb, such as the basson noise generated when the tips of the fan blades reach supersonic speeds. However, with advances in noise reduction technologies—the airframe is typically more noisy during landing¹². ¹²See, n.7, above.

The majority of engine noise is due to jet noise—although high bypass-ratio turbofans do have considerable Fan Noise. The high velocity jet leaving the back of the engine has an inherent shear layer instability (if not thick enough) and rolls up into ring vortices. This of course later breaks down into turbulence. The SPL associated with engine noise is proportional to the jet speed (to a high power) therefore; even modest reductions in exhaust velocity will see a large reduction in Jet Noise¹³. ¹³See, n.7, above.

Cockpit and cabin pressurization and conditioning systems are often a major contributor within cabins of both civilian and military aircraft. However, one of the most significant sources of cabin noise from commercial jet aircraft, other than the engines, is the Auxiliary Power Unit (APU), an on board generator used in aircraft to start the main engines, usually with compressed air, and to provide electrical power while the aircraft is on the ground. Other internal aircraft systems can also contribute, such as specialized electronic equipment in some military aircraft¹⁴. ¹⁴See, n.7, above.

There are health consequences of elevated sound levels. Elevated workplace or other noise can cause hearing impairment, hypertension, ischemic heart disease, annoyance, sleep disturbance, and decreased school performance. Although some hearing loss occurs naturally with age, in many developed nations the impact of noise is sufficient to impair hearing over the course of a lifetime. Elevated noise levels can create stress, increase workplace accident rates, and stimulate aggression and other anti-social behaviors¹⁵. ¹⁵See, n.7, above.

A large-scale statistical analysis of the health effects of aircraft noise was undertaken in the late 2000s by Bernhard Greiser for the Umweltbundesamt, Germany's central environmental office. The health data of over one million residents around the Cologne airport were analyzed for health effects correlating with aircraft noise. The results were then corrected for other noise influences in the residential areas, and for socioeconomic factors, to reduce possible skewing of the data. The study concluded that aircraft noise clearly and significantly impairs health, with, for example, a day-time average sound pressure level of 60 decibel increasing coronary heart disease by 61% in men and 80% in women. As another indicator, a night-time average sound pressure level of 55 decibel increased the risk of heart attacks by 66% in men and 139% in women. Statistically significant health effects did however start as early as from an average sound pressure level of 40 decibel¹⁶. ¹⁶See, n.7, above.

According to the FAA a maximum day-night average sound level of 65 dB is incompatible with residential communities. Communities in affected areas may eligible for mitigation such as soundproofing¹⁷. ¹⁷See, n.7, above.

Noise associated with aircraft does not only affect people on the ground, but also those within the aircraft (e.g., flight crew, cabin crew and passengers). While there appears to be little research in this area, lower noise inside the aircraft is widely promoted as a benefit for new aircraft. The noise levels inside an Airbus A321 during cruise have been reported as approximately 78 dB (A). During taxi when the aircraft engines are producing minimal thrust, noise levels in the cabin have been recorded at 65 dB(A).This is approximately 20 decibels louder than recommended acceptable levels for an office but 20 decibels below the occupational noise exposure limits of 85 dB(A)¹⁸. ¹⁸See, n.7, above.

Simulated aircraft noise at 65 dB(A) has been shown to negatively affect individuals' memory and recall of auditory information. In one study comparing the effect of aircraft noise to the effect of alcohol on cognitive performance, it was found that simulated aircraft noise at 65 dB(A) had the same effect on individuals' ability to recall auditory information as being intoxicated with a Blood Alcohol Concentration (BAC) level of at 0.10. A BAC of 0.10 is double the legal limit required to operate a motor vehicle in many developed countries such as Australia¹⁹. ¹⁹See, n.7, above.

A new noise cancelation method and process is required that addresses the above noted deficiencies of the conventional noise reduction methods and systems used in aircrafts.

### SUMMARY OF THE INVENTION

The Active Noise Cancellation (“ANC”) for Aircraft of the present invention is a system includes both analog and digital components that is specifically designed for reducing and eliminating ambient noise in an enclosed cabin environment specifically found in aircrafts. The method and system is dynamic in that it continuously monitors and changes as the ambient noise in the cabin changes.

The inventive ANC for Aircraft system includes two or more microphones that are placed in the target cabin in which noise reduction is sought, preferably the microphones are situated in equal distances in the horizontal and perpendicular directions corresponding to a two-dimensional plane. Each microphone monitors sound waves in its corresponding zone and the overlaps of any of its surrounding zones. The number of microphones and zones will be determined by the size of the enclosed cabin the system is used in. Preferably, the microphones are of the Cardioids type.

The signals from the microphones are fed to an analog to digital converter, which converts the analog signals received from the microphones to digital signals. The converted digital audio is analyzed for content and ambient noise is identified for further processing. The ambient noise is monitored for changes. There could be a single or multiple noise frequencies that are identified and subsequently monitored.

Changes to the amplitude, frequency and phase of the ambient noise are subsequently performed as necessary. Phase Modulator dynamically changes the phase of the ambient noise, always in a negative amount, of the digital audio received. The negative phase sound is added back to the original noise which results in a reduction or cancellation of the sound wave corresponding to the noise. These changes are dynamic and self adjusting in nature. The modified, noise corrected digital sound output is changed back to an analog signal and fed into the audio playback system for noise reduction.

### BRIEF DESCRIPTION OF THE DRAWINGS

FIG. 1 is a block diagram depicting a conventional noise cancellation method.

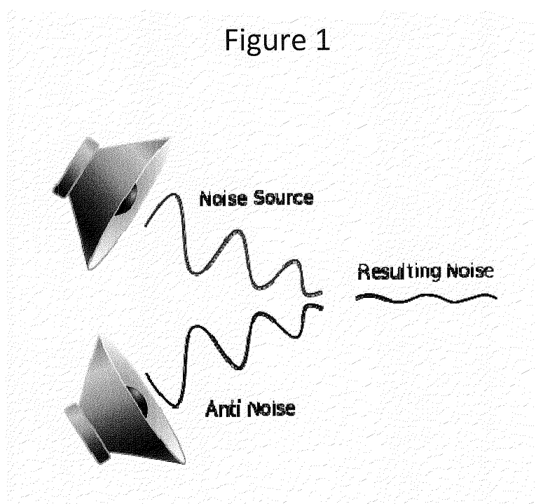

FIG. 2 Shows the polar pattern corresponding to a conventional Cardiod microphone.

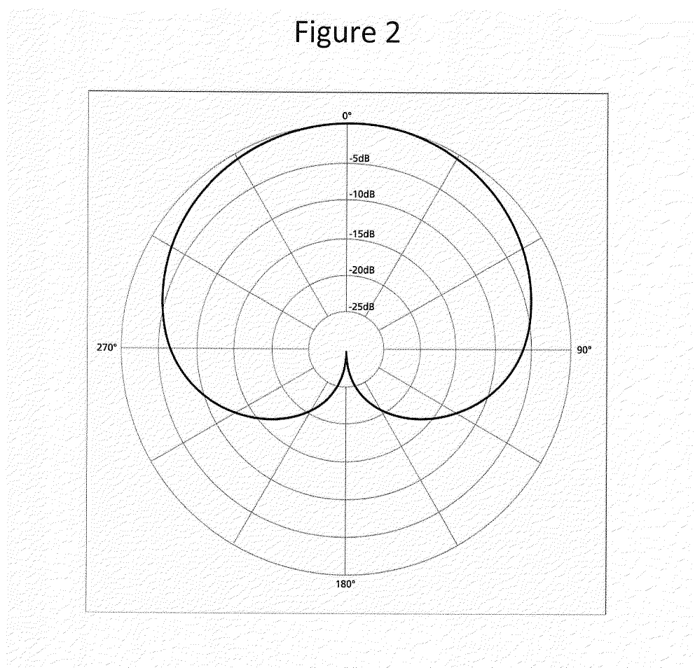

FIG. 3 is a block diagram showing the operation of the present invention according to an exemplary embodiment.

FIG. 4 shows a typical cabin setup for the Active Noise Cancellation for Aircraft system.

FIGS. 5(a) and 5(b) are exemplary illustrations of how the inventive process determines and differentiates noise from desirable audio.

### DETAILED DESCRIPTION OF THE PREFERRED EMBODIMENT(S)

The Active Noise Cancellation for Aircraft is a system for decreasing ambient noise in an Aircraft. As pointed out above, this system is dynamic in that it is constantly monitoring and changing as the ambient noise in the Aircraft cabin (referred to as “cabin”) changes. The system consists of both analog and digital components. According to one embodiment, the microphones in the cabin are laid out in equal distances and monitor both its own zone and the overlaps of any zones around it. The number of microphones and zones will be determined by the size of the cabin the system is used in, four would be typical in an Aircraft. They are all converted to digital and fed into a computer that will analyze, compare, and change each zone as needed in real time. According to one embodiment, a single zone will have multiple filters with varying frequencies and widths.

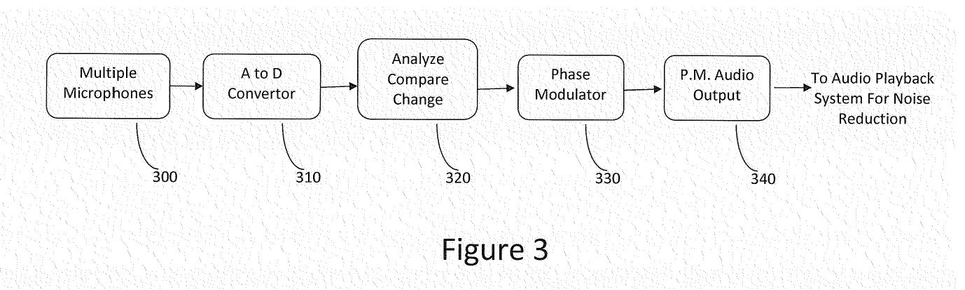

An embodiment of the operation of the Active Noise Cancellation (ANC) technique of the present invention is depicted in the block diagram of FIG. 3. Preferably, the inventive ANC process for Aircraft is performed by a single module identified by reference numeral 330 in the system shown in the block diagram of FIG. 3.

As shown in FIG. 3, multiple microphones 300 provide the input audio source received for further analysis and processing. Preferably, the microphones 300 are of the Cardioid type. Preferably, the microphones 300 are spaced in the cabin in equal distances from each other in horizontal and vertical directions in a plane.

The input audio from Multiple Microphones 300 is fed to an analog-to-digital (A/D) convertor 310, where the input audio analog signal is converted to a digital format.

The converted digital audio from the A/D convertor 310 is fed to the inventive Analyze/Compare/Change module 320 for processing. The module 320 performs several steps on the sound wave it receives from the A/D converter 310 which will ultimately result in an audio sound with reduced or cancelled ambient noise levels.

In the Analyze step, A/D converted audio sound 310 is analyzed for content and ambient noise is identified. Once the noise wave is identified, it is further analyzed for frequency, amplitude and phase values. The Compare step monitors the amplitude, frequency and phase of the original sound wave for changes to ambient noise are subsequently performed as needed to identify any additions or changes to the determined noise. The Change step identifies any changes that are needed to be made to the incoming digital noise in both positive and negative direction, in the identified ambient noise.

Phase Modulator step 330 dynamically changes the phase of the identified ambient noise and creates a new noise correction wave based on the digital audio received. These changes are dynamic and self adjusting in nature.

Phase Modulator Audio Output step 340 is a phase modulated audio output (digital or analog) that feeds into the existing audio system in the enclosed cabin. In this step the modified noise output from the Phase Modulator 330 is added back to the original noise in a phase shift of 90 to 180 degrees as needed to cancel out the input noise. The resulting combination of the original noise sound waves and the newly created noise correction wave will result in a reduction and cancellation of the noise present in the original audio sound. This Phase Modulation is a constantly changing amount. The amount of change is derived from the analyzing of the input noise and its amplitude plus harmonic content.

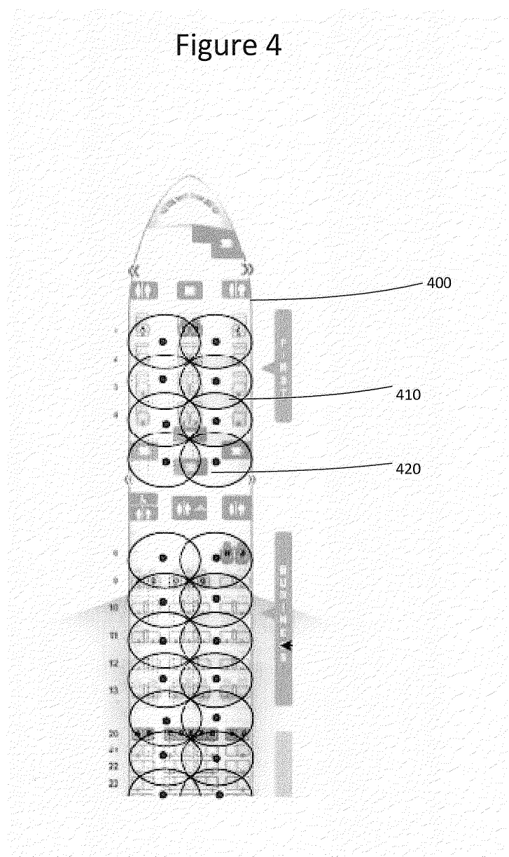

FIG. 4 shows a typical cabin setup for the Active Noise Cancellation for Aircraft system according to an embodiment of the present invention. The Aircraft 400 is divided into zones 410 with microphones 420 are placed in the center of each zone 410.

As the Aircraft's internal noise levels increase and decrease, as well as change frequencies, the system will continually “self adjust” to allow for these changes in its operation. Any sudden noises, such as dropping something, will be ignored as they are too short in duration for the system to identify them as noise. Any continually repeating frequencies would be considered noise (engines, wind on the exterior of the Aircraft, etc.). The playback for the phase changed audio would be either a dedicated one or using the existing sound system of the Aircraft if necessary.

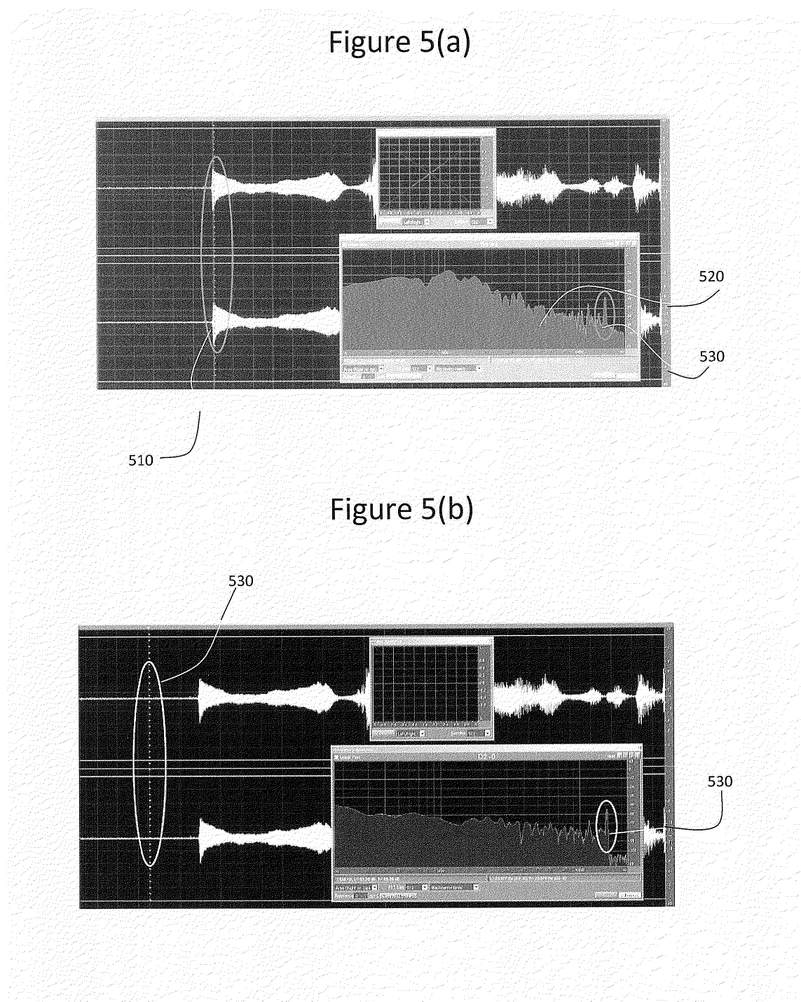

FIGS. 5(a) and 5(b) show an exemplary illustration of how the inventive process determines and differentiates noise from desirable audio. The Figures show examples of audio that includes a small amount of noise. 510 and 520 refer to the desired audio in this example. 530 identifies the audio noise in this example, which is also identified by the circles in FIG. 5(b). This particular noise is about 15.5 kHz with a narrow bandwidth, as most noise is. This spike will continue to appear through the audio clip thus identifying it as something that is constant and needs to be removed.

Although the present example discusses a single noise frequency, the invention is not limited in that way and there can be multiple noise frequencies that need to be removed. Once identified as “noise” the process will analyze for the frequency, amplitude, and phase. At this point, negative audio will be generated and summed with the original audio thus cancelling the offending “noise”. The original will continue to be monitoring the offending frequencies and if there is any change, the process will make the same change, but in a direction to ensure sure that the noise is effectively cancelled out. This will continue to dynamically monitor and generate audio until there is no input or it is bypassed. Accordingly, when the phase of the noise changes, so does the amount of negative phase audio.

What is claimed is:

1. A Noise Cancellation Process for an Aircraft cabin comprising:
Providing an input audio source from an enclosed cabin;
Converting the input audio source to a digital signal via an analog to digital (A/D) convertor;
Analyzing the A/D converted audio for content and identifying ambient noise;
Determining frequency, amplitude and phase of the identified ambient noise;
Generating a noise correction sound wave with negative phase of that corresponding to the identified ambient noise;
Summing the noise correction sound wave and the identified noise sound wave to create a noise corrected audio sound wave.
Outputting the noise corrected audio sound with diminished noise.

2. The Noise Cancellation Process of claim 1 wherein the negative phase is a phase shifted wave with a shift of between 90 and 180 degrees from the original phase amount.

3. The Noise Cancellation process of claim 1 further comprising monitoring the A/D converted audio for changes in the ambient noise and identifying any additional noise waves.

4. The Noise Cancellation Process of claim 1, wherein the input audio source is received from multiple microphones situated in the enclosed cabin.

5. The Noise Cancellation Process of claim 4, wherein the microphones are of Cardiod type.

6. The Noise Cancellation Process of claim 6, wherein the microphones are located at the four corners of the Aircraft.
